(19) United States
(12) Patent Application Publication
(10) Pub. No.: US 2005/0111933 A1
(43) Pub. Date: May 26, 2005

(54) Self-locking fastener

(75) Inventor: Keith James Carqueville, Bayview (AU)

Correspondence Address: Keith James Carqueville, PO Box 51, Frenchs Forest NSW, 2086, AU

(73) Assignee: Mirage Australasia Pty. Ltd, Bayview (AU)

(21) Appl. No.: 10/503,902

(22) PCT Filed: Feb. 14, 2003
(86) PCT No.: PCT/AU03/00185

(30) Foreign Application Priority Data
Feb. 15, 2002 (AU) PS 0557

(51) Int. Cl. F16B 39/10

(52) U.S. Cl. 411/256

(57) ABSTRACT

A self locking fastener (30) including a blind bore (12) sized to recieve a male threaded component, the male threaded component engaging or forming a complementary thread on at least part of inner surface of the blind bore (12), at least one first part of the bore (12) being an interference fit with the thread of the male threaded component.

### TECHNICAL FIELD

This invention relates to fasteners and more particularly to self-locking fasteners or nuts that connect to an exposed threaded bolt or axle and protect the end of the bolt or axle from damage.

### BACKGROUND ART

In many applications self-locking fasteners are required. Self-locking fasteners exist, but these comprise a conventional nut with a hollow Nylon insert on the outer end. Peening part of the nut over the insert retains the Nylon insert, but this is complex and expensive. In some applications where a nut is placed on the end of a bolt, threaded axle or rod or similar object having a male thread formed thereon (hereinafter referred to as a bolt) to secure an item, the bolt extends through the nut and is thus exposed to damage. If the thread becomes damaged it may be impossible to replace the nut without recutting the thread on the bolt. Severe damage may result in the need to replace the bolt. Where the bolt is part of another component, severe damage to the bolt may require replacement of the entire component.

### DISCLOSURE OF THE INVENTION

In one broad form the present invention provides a self locking fastener, the fastener including of a resilient material, the resilient material having an inner end and an outer end and including a blind cylindrical bore extending into the fastener from the inner end, the bore having an open end and a closed end, wherein at least a first part of the bore is adapted to receive a male threaded component, and wherein the first part of the bore is unthreaded and has a diameter such that the male threaded component forms a female thread in the surface of the first part when screwed into the bore.

The bore may be of constant diameter or may be tapered. A tapered bore is preferred over a bore of constant cross section.

The fastener is preferably formed of a polyamide, such as Nylon and more preferably of PA 6E Nylon. Other resilient plastics or other resilient materials may be used.

In preferred forms of the invention the bore includes a second part adjacent the open end that is of a larger diameter compared to the first part. In some forms of the invention the second part may be cylindrical but of a slightly larger diameter, so as to aid centring of the fastener on the male threaded component. The second part may have a constant diameter or may be tapered. In other forms of the invention the second part may be a recess sized to receive a conventional nut.

The fastener, in some forms of the invention, has a cylindrical outer surface. In other forms the outer surface may have a hexagonal or other polygonal outline. The outer end of the fastener may be flat, part spherical or part elliptical or any other shape. In preferred forms of the invention the outer end is in the shape of a truncated cone.

Where the outer surface of the fastener has a circular outline, preferably the outer end includes structures by which the fastener may be rotated. In preferred forms of the invention there are provided two or more recesses or bores to aid rotation. Preferably the recesses are provided as one or more pairs of diametrically opposed recesses.

Preferably the inner end of the fastener is substantially planar. In some forms of the invention the inner end may include one or more protrusions extending axially from the generally planar end. The protrusions may be one or more annular rings or arcs coaxial with the bore. In preferred forms of the invention a single annular ring is provided with an inner diameter substantially the same as that of the outer part of the bore.

The inner end of the fastener may also include retaining structures to retain or position a sealing and/or lubrication pad, gasket or seal on or adjacent the end of the fastener. In preferred forms the protrusion(s) on the inner end also serve this function.

In some forms of the invention the outer periphery of the fastener includes one or more radially extending protrusions, more preferably at least one radially extending ring.

In further forms of the invention, the fastener includes a bore having a threaded portion and an interfering portion that engages and interferes with the thread of the bolt that is screwed into the threaded component. In one form the threaded portion is provided by one component and the interfering portion is provided by a second component. In one form the second component is a washer that has a bore through which the threaded bolt passes. The bore of the washer is smaller than the maximum diameter of the threaded bolt and preferably smaller than the minimum diameter of the threaded bolt and so permanently interferes with the bolt, thereby resisting rotation of the fastener relative to the bolt, whether the fastener is tight or not.

In further forms of the invention of the interfering portion may be part of or may be mounted on or in a component that provides the threaded portion. The interfering portion extends into the volume through which the bolt passes, so as to engage the bolt as it is threaded on to the threaded component. The interfering portion may be provided by one or more separate components and these components may be one or more plugs or inserts of a resilient material located in the thread of the threaded portion. These plugs may be cylindrical or longitudinal inserts. The plugs may be received within respective recesses in the wall of the threaded portion. These recesses may also extend through the wall of the threaded portion.

In other forms part or all of the threaded portion may be formed so that the thread has a diameter smaller than normal for the male thread, so that when engaged the reduced diameter thread creates additional resistance against rotation of the male thread in the female thread.

The threaded component is preferably encased in a shell that closes the bore into which the bolt enters, thereby protecting the free end of the bolt. The shell may have an internal bore into which the bolt extends. The threaded component preferably has an outer surface that prevents the rotation about the axis of the threaded bore of the threaded component relative to the shell in which it is encased. In its broadest form, the outer surface of the threaded component merely requires a portion that is non-circular when viewed axially.

The threaded component also preferably has an outer surface that prevents the threaded component being pulled out of the shell axially, such as when the fastener is tightened. In its broadest form the outer surface of the threaded component has first and second portions encased in the shell with the second portion is located axially inwardly in the shell relative to the first portion and which extends radially further from the axis than the first portion. In a preferred embodiment the threaded component includes a planar hexagonal portion that serves to prevent rotation of the threaded component of relative to the shell. In a preferred embodiment the threaded component also has a cylindrical portion and a hexagonal portion that is located at the inner end of the cylindrical portion. The hexagonal portion is encased in the shell and at least part of the cylindrical portion is also encased in the shell. The hexagonal portion extends radially more than the cylindrical portion and so prevents the threaded component being pulled out of the shell and rotated relative to the shell.

In a preferred embodiment, the recesses provided in the shell to enable the shell to be tightened onto the bolt extend to a washer provided as an interfering component that is encased in the shell. During manufacture the threaded component and the interfering washer are mounted on to a pin that extends into a plastics injection-moulding cavity. Another part of the cavity is provided with two second pins that extend through the cavity and engage the washer and push it and the threaded component tightly against each other. Plastics material is then injected into the cavity so forming the shell and encasing the threaded component and the interfering washer in the shell material. The first pin is a relatively tight fit into the bore of the washer and accordingly no shell material, or very little shell material, escapes from the cavity via any gaps between the washer and the first pin into the thread area of the threaded component. The two retaining pins form the recesses that in the finished product are used for tightening the fastener. The first pin extends beyond the washer and so forms a blind bore in which the free end of the bolt to which the fastener may be attached may extend into. By using a first pin of a constant diameter and a suitable material for the shell this blind bore may also serve to interfere with the thread of the bolt and so restraint or prevent rotation of the fastener relative to the bolt, irrespective of whether the fastener is tight or not.

It will be appreciated that the invention is not limited to manufacture by a plastics injection-moulding process and that other materials and processes may be used. Examples of other processes include die casting and pour casting. Other materials that may be used include metals, ceramics and other polymers such as if urethanes.

The invention will be better understood from the following, non-limiting description of preferred embodiments and the drawings.

### BRIEF DESCRIPTION OF THE DRAWINGS

FIG. 1 is a top view of a first embodiment of the invention;

FIG. 2 is a cross sectional view taken along line AA of FIG. 1;

FIG. 3 is a top view of a second embodiment of the invention;

FIG. 4 is a cross sectional view taken along line AA of FIG. 3;

FIG. 5 is a top view of a third embodiment of the invention;

FIG. 6 is a cross sectional view taken along line AA of FIG. 5;

FIG. 7 is a top view of a fourth embodiment of the invention, and

FIG. 8 is a cross sectional view taken along line AA of FIG. 7;

FIG. 9 is a perspective sectional view of a 4th embodiment of the invention;

FIG. 10 is an exploded perspective view of the embodiment of figure nine;

FIG. 11 is a cross sectional view of the embodiment of FIG. 9 taken along the axis;

FIG. 12 is a perspective view of a nut component of the embodiment of figure nine;

FIG. 13 is an axial cross sectional view of the nut of FIG. 12;

FIG. 14 is a perspective view of a washer component of the embodiment of FIG. 9;

FIG. 15 is a side view of the washer of FIG. 14;

FIG. 16 is an end view of the washer of FIG. 14.

FIG. 17 is an end view of the fastener of FIG. 9;

FIG. 18 is an axial cross-sectional view of the shell of the fastener of FIG. 9;

FIG. 19 is a reverse perspective view of the fastener of FIG. 9;

FIG. 20 is an axial cross sectional view of a first variation of the nut component of FIG. 12.

FIG. 21 is an axial cross sectional view of a second variation of the nut component of FIG. 12.

FIG. 22 is a plan view of an alternative washer for use with the embodiment of FIGS. 9 to 19;

FIG. 23 is an axial cross sectional view of an alternative to nut component for use with the embodiment of FIGS. 9 to 19;

FIG. 24 is a plan view of a further alternative nut component for use with the embodiment of FIGS. 9 to 19;

FIG. 25 is an axial cross sectional view of the component of FIG. 24, taken along lines B-B of FIG. 24.

### BEST MODE OF CARRYING OUT THE INVENTION

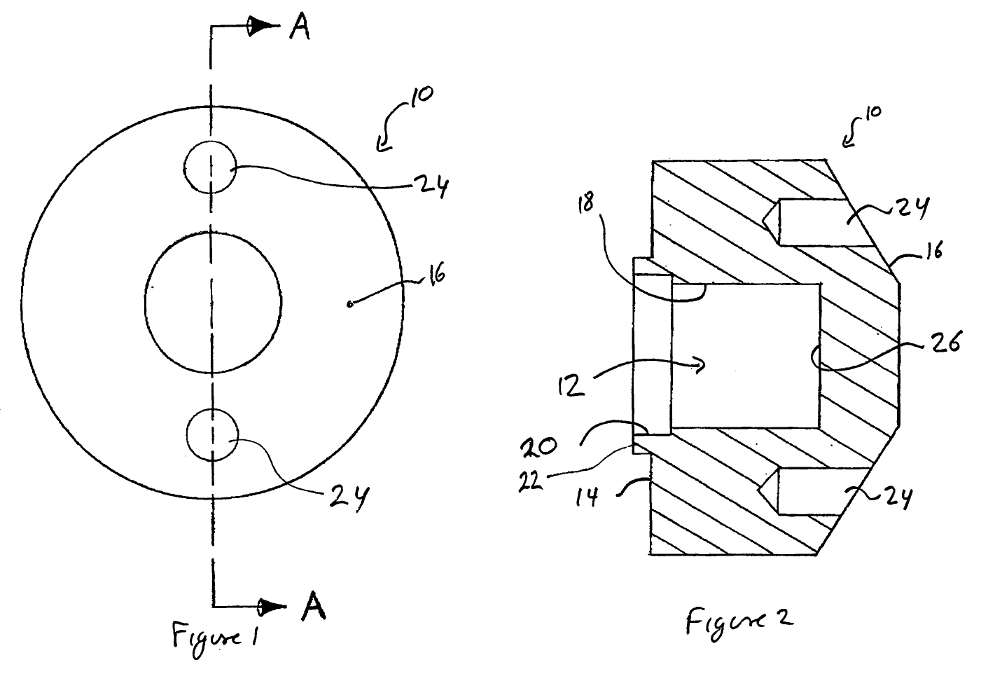

Referring to FIGS. 1 and 2, there is shown a self-locking fastener 10 according to a first embodiment of the invention. The fastener 10 is circular in plan view, but this is not essential. The fastener 10 is provided with a blind, central bore 12. The bore 12 extends from the inner end 14 of the fastener toward the outer end 16. The bore 12 has an inner portion 18 and an outer portion 20. The diameter of portion 20 is larger than the diameter of portion 18. The inner end 14 is generally planar and perpendicular to the axis of the bore 12 but has a small annular ring 22 extending around part of the outer portion 20 of the bore. The outer bore 20 has a length greater than that of the ring and so extends into the general body of the fastener. This is not important and the length of the outer bore may the same as that of the ring 22 or it may be less. As will be explained later, one or both of the outer bore 20 and the annular ring 22 may be omitted. Where the outer bore is omitted, the bore 12 will preferably have a constant diameter along its length.

The outer end 16 of the fastener is a truncated cone, but this is not essential and, for example, a planar surface perpendicular to the axis of the bore 12 or a part spherical or elliptical surface may be provided. Located in the outer end 16 are two diametrically opposite blind bores 24. These are shown as having a tapered inner end 26, but this is not essential and a planar end may be provided.

The fastener 10 is manufactured from a resilient material and more preferably a polyamide (Nylon) and more preferably PA 6E Nylon. However, other suitable materials may be used. The inner portion 18 of the bore 12 is sized so that it may be screwed onto a suitable bolt, with the bolt forming a female thread into the bore 12 when inserted into the fastener. Thus the diameter of the inner portion 18 of the bore 12 is slightly less than the outside diameter of the threaded portion of the bolt and slightly greater then the inner diameter of the threaded portion of the bolt. Thus as the bolt is screwed onto the fastener, the material of the fastener adjacent the bore may be formed into a thread without removal of fastener material. For a 5/16 inch (7.9375 mm) bolt, an inner diameter of about 7.19 mm provides a suitable compromise between ease of attachment and tightness. Obviously other size bolts will require appropriately sized bores.

In use the fastener is located on the free end of a bolt with the end of the bolt inserted into the outer portion 20 of the bore. The outer portion 20 serves to aid in centring the fastener on the bolt. The fastener is then rotated using a suitable tool inserted into the two bores 24 whilst being pushed toward the bolt. This causes the bolt to commence forming a thread in the bore. Once the bolt has been inserted a small amount it is merely necessary to rotate the fastener relative to the bolt, with the formed thread drawing the fastener onto the bolt.

The length of the bore 12 is such that for most situations the fastener and bolt will become tight with the annular ring 22 limiting tightening before the free end of the bolt contacts the blind end 26 of the bore. Thus when the fastener and bolt combination is assembled the free end of the bolt is protected within the fastener from damage.

The annular ring 22 serves at least two purposes. If the fastener 10 is being used to retain a bearing or a device with a bearing, such as a skateboard wheel, the annular ring will contact the inner race of the bearing and prevent the fastener contacting the outer race of the bearing. A sealing and/or lubrication pad (not shown) may also be placed on the inner end 14 of the fastener around the ring 22 to serve as a protective device for a bearing, so as to prevent or limit ingress of dirt and debris into the bearing. The pad may be a felt disc and optionally may be impregnated with oil or the like to provide lubrication to the bearing. The diameter of the pad may be the same, greater or smaller than the diameter of the fastener, depending of intended use. The pad may be made from other suitable materials.

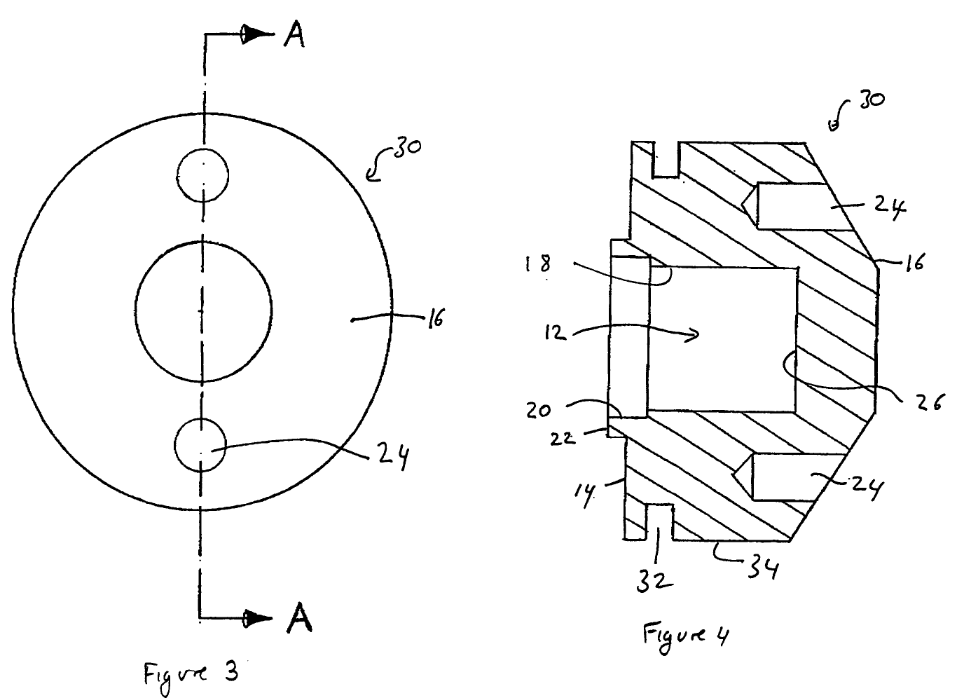

FIGS. 3 and 4 show a self-locking fastener 30 according to a second embodiment of the invention, substantially the same as the embodiment of FIGS. 1 and 2. Accordingly, the same numerals are used to indicate the same features. The fastener 30 has a circumferential groove 32 extending into the sidewall 34. This groove is adjacent the inner end 14 and is provided so that a protective disc may be mounted on the side of the fastener in addition or as an alternative to mounting on the inner end.

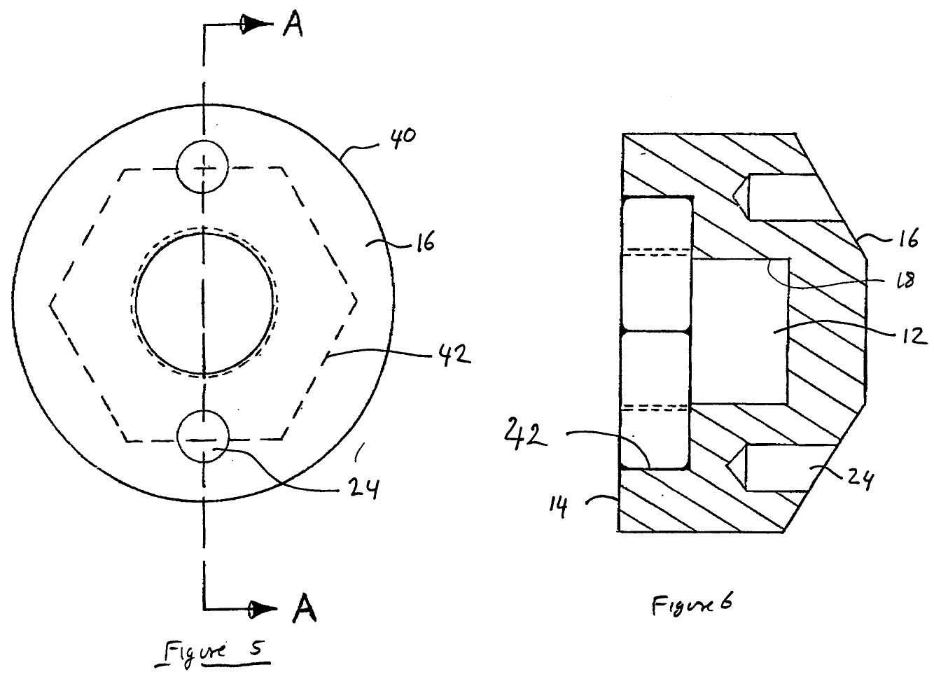

FIGS. 5 and 6 show a self-locking fastener 40 according to a third embodiment of the invention. Features common to the embodiment of FIGS. 1 and 2 are indicated with the same numbers. The fastener 40 is circular in plan view and has a similar truncated cone outer end 16. However, the inner end is planar, without an annular ring extending out of the general plane of the inner end. As with the other embodiments, a blind bore 12 is provided, open at the inner end 14. The inner portion 18 of the bore is sized so that a bolt will form a thread. In contrast to the other embodiments, the outer portion 42 of the bore 12 is not a slightly oversize circular bore. Instead the outer portion is a hexagonal recess sized to snugly accept a conventional nut of the size that will screw onto the same size thread as the inner portion 18. The recess is preferably an interference fit with a conventional nut so that a conventional nut may be pushed into the recess 42 and retained. The resilient nature of the material of the fastener 40 aids in retention of the conventional nut.

In use the conventional nut (not shown) is inserted into the recess 42 and then threaded onto the bolt. If the nut may be screwed onto the bolt so that the bolt extends through the conventional nut, the bolt will commence to form a thread in the inner portion 18 of the bore 12, so aiding retention of the fastener 40 on the bolt. As with the first two embodiments, the end of the bolt is protected from damage by the outer end 16 of the fastener 40. It will be appreciated, since the fastener 40 utilises the conventional nut, that it is mainly intended as a protective cap to prevent damage to the (normally) exposed end of the bolt, rather than as a retro fit after the bolt has been damaged.

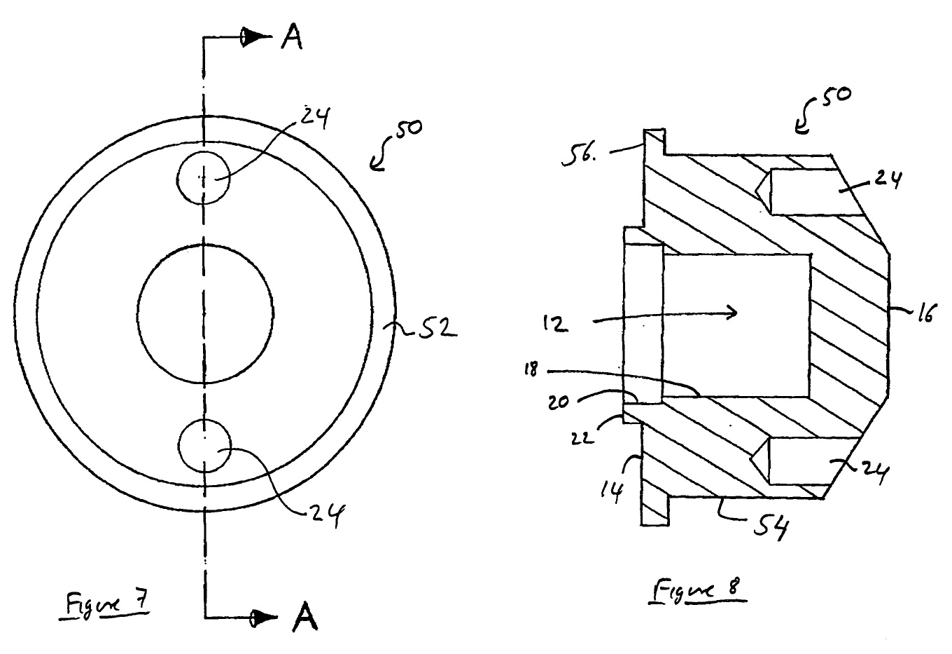

FIGS. 7 and 8 show a self-locking fastener 50 according to a fourth embodiment of the invention, substantially the same as the embodiment of FIGS. 1 and 2. Accordingly, the same numerals are used to indicate the same features.

The fastener 50 is substantially the same as the fastener 10 of FIGS. 1 and 2 except that it also has an annular ring 52 extending radially outward from the circumferential side surface 54. The ring 52 is located adjacent the inner end 14 of the fastener 50, with its inner face 56 coplanar with the inner end 14. It is not essential that the inner face 56 is coplanar with inner end 14 and the ring 52 may be located away from the inner end. The ring 52 provides some protection to a bearing or the like. It will be appreciated that other materials, including those previously mentioned, may be used for the various components.

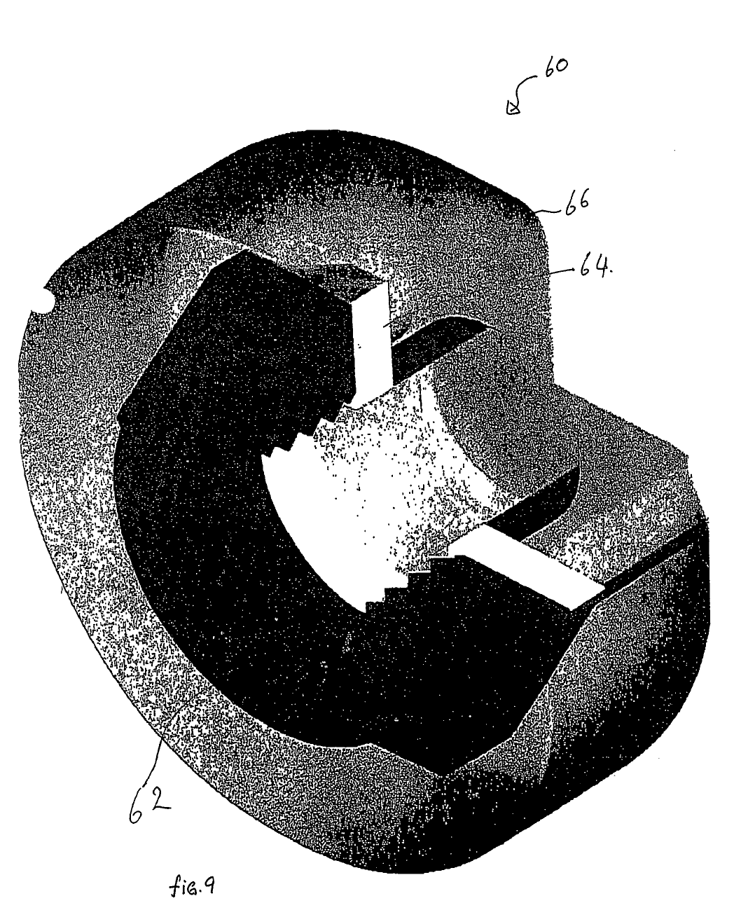

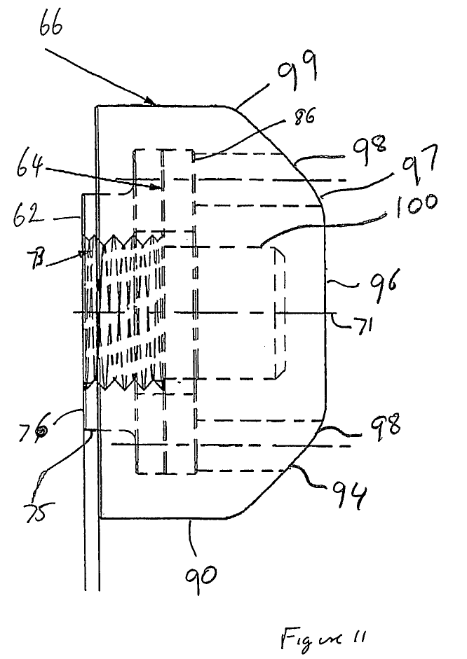

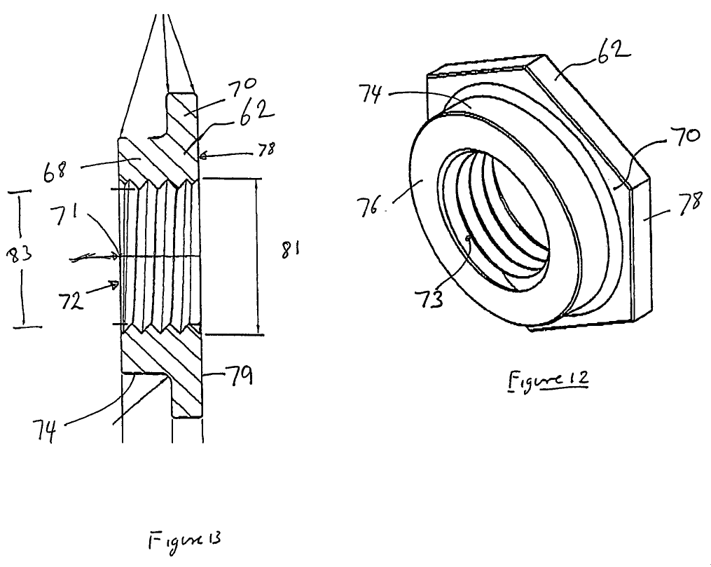

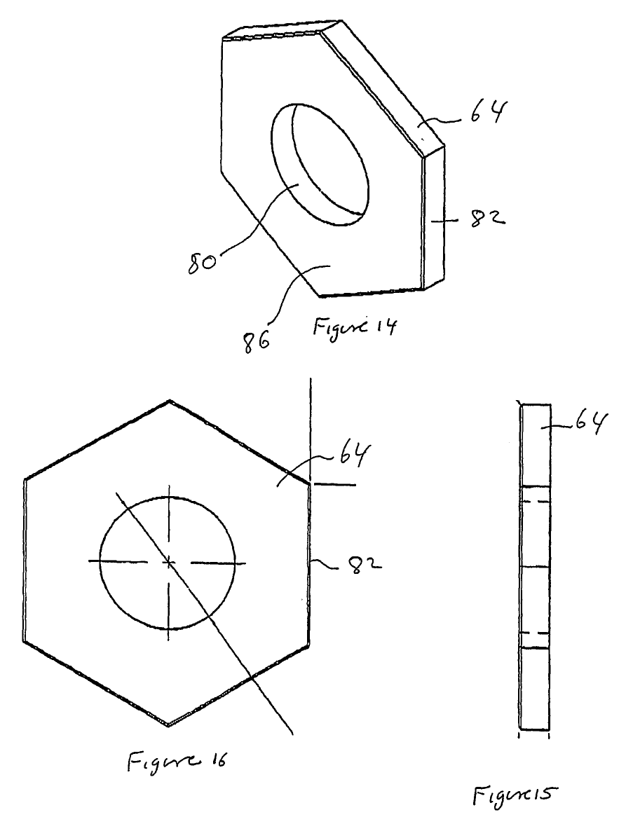

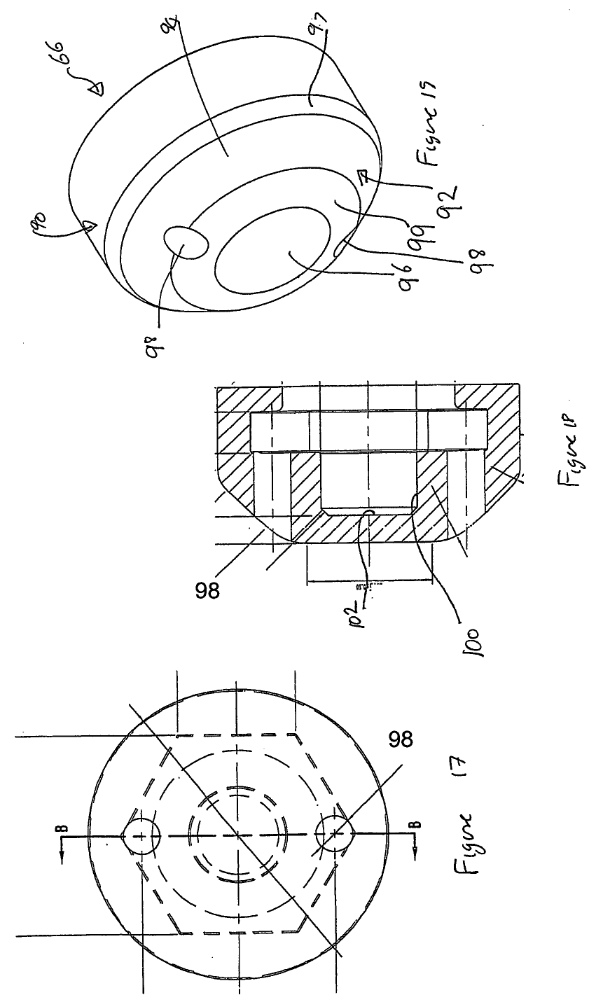

Referring to FIGS. 9 to 19 there is shown a fifth embodiment of the invention comprising a compound fastener 60. The fastener 60 includes a metal threaded inner nut 62, a washer 64 and a plastics or polymer outer shell 66.

The fastener 60 is preferably formed by a plastics injection moulding process with the nut 62 and the washer 64 encased in the shell 66.

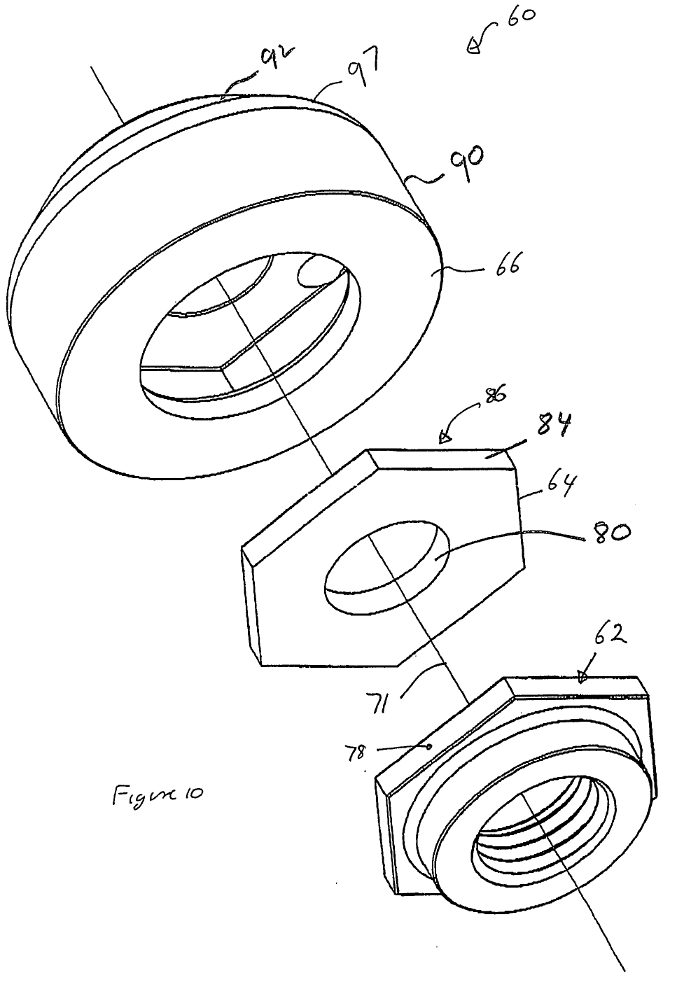

The nut 62 includes first and second portions, 68 and 70. A bore 72 centred on axis 71 extends through both portions and is provided with a thread 73. The first portion 68 has a cylindrical outer surface 74 and a planner outer end 76. It is not critical that the surface 74 be cylindrical, as will be explained later. As seen in FIGS. 9 and 11 a portion 75 of the nut extends out of the shell 66.

The second portion 70, which is preferably formed integrally with the portion 68, in cross-section is planner and has a hexagonal shaped periphery 78 and extends radially more than the first portion 68. The second portion 70 serves to prevent the nut 62 being pulled axially out of the shell 66 and to prevent the nut 62 rotating about the axis 71. As such it is desirable that parts extend radially more than the cylindrical surface 74 and, if the first portion 68 is circular, the periphery 78 is non-circular. It will be appreciated that the periphery need not be hexagonal and may be a polygon of any number of sides, such as a triangle, quadrilateral, pentagon its etc. or may have a non-circular curved profile such as an oval or an ellipse. The periphery does not need to be a regular shape and may be an irregular shape.

It will be appreciated that the distinction between the two portions 68 and 70 is somewhat artificial and that it is merely necessary that the nut 62 as a whole has features to prevent it being pulled out of the shell 66 and rotating relative to the shell 66. Thus we can consider the outer surface of the nut as a whole as requiring a surface portion that is non-circular and a surface portion remote from the outer end 76 that extends radially more than a part of the surface nearer to the outer end 76. Thus, as an example, rather than having a T-shaped cross sectional shape, a nut 62 may be provided with a non-circular peripheral surface that diverges from the outer end 76 to the inner end 79.

Located internally and within the shell 66 and coaxially with the nut 62 is a resilient washer 64. The washer has a central bore 80 and a non-circular periphery 82. The diameter of the bore 80 is less than the maximum diameter of the thread 73 of the nut 62. In the embodiment shown in FIGS. 9 to 19 the diameter of the bore 80 is also a less than the minimum diameter or of the thread 73. In this embodiment the thread 73 is a 5/16th inch UNF thread. This provides a maximum diameter of 7.95 mm at the troughs of the thread and a minimum diameter of 6.85 mm at the peaks of the thread, as indicated by numerals 81 and 83. The diameter of the bore 80 in the embodiment is 6.7 mm, which is less than the minimum diameter 83 of the thread 73. The washer 64 is preferably formed of a resilient plastics or polymer material, such as a Nylon. A preferred Nylon is PA 6E, but other suitable materials may be used.

The periphery 82 of the washer is also hexagonal and is preferably the same size, in end view, as the hexagonal retaining portion 78 of the nut 62. The periphery 82 in this embodiment is non-circular to prevent rotation of the washer 64 in the shell 66. As such, the periphery 82 may have other non-circular shapes, such as a polygon, an oval, an ellipse or any other regular or irregular non-circular shape.

In addition or as an alternative to a non-circular periphery 82, the washer may be provided with other features to prevent rotation. Examples may include one or more ribs on the inner surface 86 and/or depressions or apertures extending into or through the washer 60 from the inner surface 86. When manufactured, the material of the shell 66 will surround any ribs and enter any depressions or apertures and so prevent rotation of the washer 64 relative to the shell 66.

The bore 80 is also sized to prevent, during manufacture, the shell material entering into the threaded bore 71 of the nut 62, as explained later.

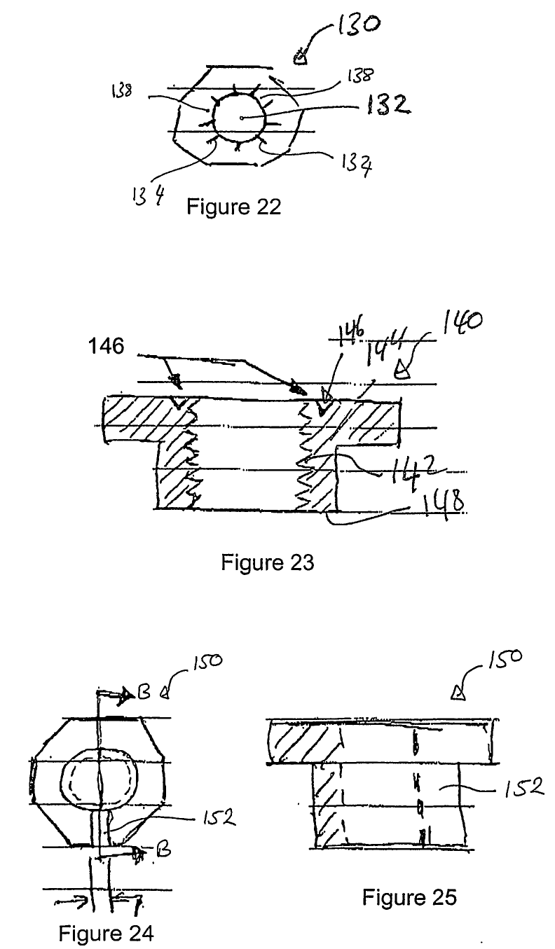

An example of an alternative washer 130 is shown in FIG. 22. The washer 130 is a thin metal washer with a bore 132 smaller than the outer thread diameter of the male thread. Extending outwardly from the periphery of the bore 132 are a, series of slits 132. Preferably the slits extend radially and more preferably they are spaced equally about the periphery. The slits thus define a series of segments 138. Preferably the bore 132 has a diameter larger than the minimum thread diameter of the male thread. Thus the segments 138 extend into the thread area of the male thread. In use the threads of the male component will engage the edges of the bore and, due to the pitch of the thread, will elastically twist each segment 138 so as to be aligned with the thread. This results in frictional resistance to rotation of the bolt similar to that provided by the resilient Nylon washer.

FIG. 23 shows a threaded component 140 that provides both retaining and interfering functions. The component 140 has a threaded bore 142. The bore 142 extends through the component to an inner end 144. The inner end 144 has one or more indents 146 punched or otherwise formed into the surface so as to swage the adjacent portion of the thread to a reduced diameter. When a bolt is threaded into the threaded component 140 from the outer end 148, it will freely engage the thread until it reaches the inner end 144. At this point the reduced diameter of the thread will fictionally engage the bolt and resist rotation.

FIGS. 24 and 25 show a further alternative threaded component 150. The component 150 is similar to the threaded component of FIGS. 9 to 19 but it has a slot 152 that extends axially along the full length of the component. The slot 152 is crimped so as to be partially closed prior to the component 150 being encased in the shell of the fastener. This reduces the diameter of the internal thread. Thus, as the bolt is screwed into the thread of the component, there will be interference and so additional resistance to rotation of the bolt relative to the component.

The shell 66 has two major portions, 90 and 92. The first portion 90 has a substantially cylindrical outer wall 90 and encases the nut 62 and a washer 64. The second portion 92 is substantially a truncated cone, with an angled sidewall 94, a central, circular, planar end wall 96 and curved intermediate walls 97 & 99. The curved intermediate walls 97 and 99 are for manufacturing ease and to provide a more rounded appearance to the fastener. The walls 97 and 99 are not essential and the angled wall 98 may extend between the cylindrical wall 90 and the end wall 96. It will be appreciated that for manufacturing purposes all corners cannot be perfect angles and will have a small radius. In the preferred embodiments the overall exterior shape of the fastener is designed to prevent excess drag or fiction if the fastener scrapes against the ground or another object.

Located in sidewall 94 are two diametrically opposed recesses 98. The recesses 98 are cylindrical bores that extend to the washer 64. The recesses 98 are to receive corresponding pins of a tightening spanner or wrench (not shown) and so need not be circular. The number of recesses may be more than two, in which case the recesses will not be spaced diametrically opposite to each other. Where three or more recesses are provided they need not be spaced equally about the axis 71 of the fastener. The recesses 98 extend to the washer 64 for ease of manufacturing and it is not critical that they do so for the working of the fastener.

The recesses 98 are provided to enable the faster to be tightened, because the outer surfaces of the shell 66 are not conducive to being gripped. It will be appreciated that a non-circular peripheral portion of the shell 66 will enable the fastener to be tightened without needing use of the recesses 98. However, it is preferred that the shell 66 be shaped as in the drawings.

The shell 66 is also provided with a plain bore 100 that is coaxial to the bores 71 and 80 extending through the nut 62 and a washer 64, respectively. The bore 100 is blind at an inner end 102. The diameter of the bore 100 in the embodiment preferably is the same as that of the bore 80 in the washer 64. This is mainly for ease of manufacturing and is not critical. The diameter 100 needs to be large enough to allow a male threaded axle or bolt to pass into the bore 100. As such a diameter smaller than the maximum thread diameter and optionally the minimum thread diameter it is acceptable. A clearance fit is also acceptable. Where the fit is an interference fit, that shell material is chosen so that the male threaded component will form a thread in the shell material, either by material being removed or by compressing or distorting the material.

In use the fastener 60 is threaded onto a threaded axle or bolt and the threaded axle engages thread 73 of the nut 62 and, as the fastener is rotated, the axle enters the bore until it reaches the washer 64. The washer is made of a resilient material. Thus, whilst the diameter of the bore in the washer 64 is smaller than the maximum thread diameter and optionally the minimum thread diameter of the thread on the axle, the axle forms a thread in the washer 64. This is achieved by displacing or distorting the material of the washer 64. This restrains rotation of the fastener 60 relative to the axle, irrespective of whether the fastener is tight or not, and so lessens the likelihood of the fastener becoming loose. Where the diameter of the bore 80 in the washer 64 is less than the minimum diameter of the thread on the axle, this means that there will always be an interference fit between the washer and the axle, even after a thread has been formed in the washer 64.

The fastener is tightened onto the axle until the end 76 firmly engages a surface being secured, such as the inner race of a bearing. Of course, one or more washers or spacers may be provided between a bearing and the fastener. As with the other embodiments, the diameter of the end 76 is chosen so that it will only contact the inner race. A lubricating and/or protective washer (not shown) may be mounted on the inner end 76 of the fastener as described with reference to some of the other embodiments.

The embodiment of FIGS. 9 to 19 incorporates a separate washer 64 that provides a resilient member that resists rotation of the fastener relative to an engaged axle. It is not critical that a separate member provides this resistance. FIG. 20 shows a nut 120 that incorporates function equivalent to the washer 64. The nut 120 includes at least one plug of a resilient material inserted into a bore 110. The bore 110 may be a blind bore that extends partially into the nut or it may be a through bore that extends from the inner threaded surface 112 to the outer surface 114 of the nut 120. The plug 108 may have a length such that when fully inserted into the bore 110 it extends inwardly at least beyond the maximum diameter of the thread 73 and preferably extends beyond the minimum diameter of the thread 73. Where the bores 110 extend fully through the wall of the nut, it will be appreciated that prior to manufacture the plugs 108 may be inserted into the bores from the outer surface of the nut until the outer end of the plug 108 is generally flush with the outer surface of the nut. The nut 62 is then encased in the shell 66 and so the plugs are prevented from radial outward movement by the shell material encasing the nut.

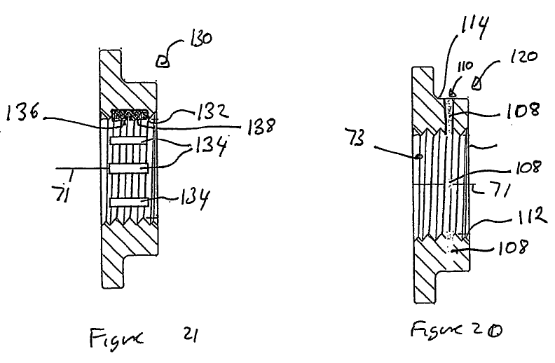

FIG. 21 shows a nut 130 that also incorporates a member functionally equivalent to the washer 64. The nut 130 of FIG. 21 has one or more slots 134 on the threaded surface 132. The slots 134 may extend parallel to the axis or may be angled to the axis. The slots 134 may extend through the wall of the nut or may only extend partially into the wall of the nut. The slots 134 may be straight but need not be. Located in each slot 134 is a resilient member 136 that extends radially inwards into at least the zone of the thread 71 and preferably radially inwardly more than the zone of the thread. Taking the embodiment of FIGS. 9 to 19 as an example, the resilient members 124 will extend so that there inner surface 138 of the resilient member 124 is 6.7 mm from the axis 71 compared to the inner diameter of the thread 71 being 6.85 mm from the axis. The slot 120 may have a constant size through the wall of the nut or it may have a varying size. For example, in axial end view, the cross-sectional shape of the slot may be T-shaped. The resilient member 124 may also be T-shaped or may be sized to merely fit into the wider portion of the slot. If the slot extends fully through the wall and is not a fully filled by the resilient member 124, when the nut 120 is encased in the shell 66, the shell material will extend into the slot or slots and so aid in preventing rotation of the nut 120 relative to the shell.

Whilst all of the embodiments shown have a bore of constant cross section, a tapering bore may be used instead with all the embodiments. The taper of the bore will be sufficient to improve the locking nature of the fastener whilst not preventing mounting of the fastener on the bolt.

All forms of the invention may be used with or without a washer sandwiched between the inner end 14 of the fastener and the object being secured.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

### Industrial Applicability

The invention has industrial applicability in providing protection of exposed threads from damage.

1. A self locking fastener including:
a blind bore sized to receive a male threaded component, the male component engaging or forming a complementary thread on at least part of the inner surface of the blind bore,
at least one first part of the bore being an interference fit with the thread of the male threaded component, and
an outer surface, the outer surface including at least two recesses located remote from the axis of the bore, whereby the fastener may be rotated about the axis.

2. The fastener of claim 1 wherein a second part of the bore has a thread that is a clearance fit with the thread of the male component.

3. The fastener of claim 2 wherein the at least one first part is located axially coincident with at least part of the second part.

4. The fastener of claim 1 wherein at least part of the bore is defined by a shell.

5. The fastener of claim 4 wherein the at least one first part is at least partially defined by the shell.

6. The fastener of claim 1 wherein the at least one first part is at least partially defined by an interference component.

7. The fastener of claim 6 wherein the interfering component is a washer that has a bore through which the threaded bolt passes.

8. The fastener of claim 7 wherein the bore of the washer is smaller than the outside diameter of the threaded bolt

9. The fastener of claim 7 wherein the diameter of the bore of the washer smaller than the inside diameter of the threaded bolt.

10. The fastener of claim 7 wherein the at least two recesses extend to the washer.

11. The fastener of claim 1 wherein the at least two recesses are parallel to the axis.

12. The fastener of claim 2 including a separate threaded component that defines at least some of the second part.

13. The fastener of claim 12 wherein the at least one first part is at least partially defined by an interfering component located axially coincident with a part of the threaded component and extending into the volume through which the male threaded component passes.

14. The fastener of claim 13 wherein the interfering component includes one or more plugs of a resilient material located in or on the thread of the threaded component.

15. The fastener of claim 12 wherein at least part of the threaded component is located in a recess in the shell.

16. The fastener of claim 15 wherein the threaded component has an outer surface that prevents the rotation off the threaded component relative to the shell.

17. The fastener of claim 15 wherein the outer surface of the threaded component has at least a portion that is non-circular when viewed along the axis of the bore.

18. The fastener of claim 15 wherein the threaded component has an outer surface that prevents the threaded component being pulled out of the shell axially.

19. The fastener of claim 15 wherein the outer surface of the threaded component has a first portion and a second portion in which the second portion is located axially inwards in the shell compared to the first portion and extends radially further from the axis than the first portion.

20. The fastener of claim 12 wherein the threaded component has a cylindrical portion and a hexagonal portion located at one end of the cylindrical portion and wherein the hexagonal portion and at least substantially the entire cylindrical portion are encased in the shell.

21. The fastener of claim 20 wherein the hexagonal portion extends radially more than the cylindrical portion.

22. The fastener of claim 1 wherein at least part of the outer surface having a profile selected from a group including a cylinder, a polygon and an oval.

23. The fastener of claim 22 wherein, when viewed along the axis, the outer surface is substantially circular or oval.

24. The fastener of claim 1 wherein a free end part of the first portion extends out of the shell and, in use, bears against an object being secured.

25. The fastener of claim 1 wherein the male component forms a female thread in the surface of the at least one first part when screwed into the bore.

26. The fastener of claim 1 wherein the at least one first part is at least partially defined by a resilient material.

27. The fastener of claim 26 wherein the resilient material is a polyamide.

28. The fastener of claim 1 wherein the diameter of the bore is tapered.
